(19) United States
(12) Patent Application Publication
(10) Pub. No.: US 2010/0251371 A1
(43) Pub. Date: Sep. 30, 2010

(54) REAL-TIME MALICIOUS CODE INHIBITOR

(76) Inventor: Jeff Brown, Findlay, OH (US)

Correspondence Address: CURTIS, MALLET-PREVOST, COLT & MOSLE, LLP, 101 PARK AVENUE, 34TH FLOOR, NEW YORK, NY, 10178-0061, US

(21) Appl. No.: 12/749,469

(22) Filed: Mar. 29, 2010

Related U.S. Application Data
(60) Provisional application No. 61/211,282, filed on Mar. 27, 2009.

(51) Int. Cl. G06F 11/00

(52) U.S. Cl. 726/23

(57) ABSTRACT

A method and system for real-time blocking of malicious requests to a compute system and real-time removal of malicious code from such requests, by comparing the request information to a database of known and recorded malicious requests. If it is determined that the request is from an IP address that is restricted or has previously attacked another system, the request may be denied, the request information will be logged, the incident will be reported to the user and also SecurePlus if the user has subscribed to SecurePlus. If the request is not denied, it will be parsed and searched for inclusion of remote files, database code, programming code, known hacking terms, and user-supplied terms. If the presence of any of these items is detected, the request may be denied, the request information will be logged, the incident will be reported to the user and also SecurePlus if the user has subscribed to SecurePlus. If the request in question has been denied, a cookie will be inserted onto the requesting system to assist in detection of known attackers.

### CROSS-REFERENCE TO RELATED APPLICATION

This application claims the benefit of the tiling of U.S. Provisional Application No. 61/211,282, filed Mar. 27, 2009, which is hereby incorporated herein by reference.

### FIELD

This application relates to information security, and, more particularly, to a system and method for preventing exploitation of vulnerabilities in websites.

### BACKGROUND

Websites today are capable of providing dynamic content to users by generating real-time Hyper Text Markup Language (“HTML”) that controls the way websites are executed within web browsers. Dynamic content make a user's experience more enjoyable by customizing websites for particular users. These websites, however, are vulnerable to attackers who take advantage of these dynamic capabilities by injecting malicious code within client web requests.

With sufficient forethought and analysis, an attacker may exploit flaws in dynamic websites by embedding scripting elements within the returned dynamic content without the user's knowledge. Cross-site scripting (“XSS”) is a technique for exploiting vulnerabilities in dynamic websites by injecting malicious code into otherwise benign and trusted websites. The malicious code is inserted through the use of cleverly crafted Uniform Resource Locators (URL″) or Structured Query Language (“SQL”) statements. An XSS vulnerability exists when a web-based application fails to correctly validate user input data before returning it to the client system. By causing the victim's browser to execute injected code under the same permissions as the web application domain, the attacker bypasses the traditional security restrictions, which can result in cookie theft, account hijacking, spreading of a web mail worm, etc.

The following is an example of a basic XSS attack through the use of a known dynamic web scripting language commonly referred to as PHP. By way of example, assume a web page named hello.com includes a PHP script named hello.php. Also, assume that hello.com contains a form allowing a user to type and submit his name, which is then displayed on the page. Assume a user “John Smith” types his name into the form on the web page. The URL passed to the server would be the following:
http://www.hello.com/hello.php?name=John Smith

Using conventional “GET” or “POST” commands to retrieve the value of the variable “name”, the browser will display the name “John Smith” on the web page hello.com. Assume, however, that John Smith is an attacker that wishes to insert the execution of a script containing malicious code. Instead of entering his name, the attacker may type an HTML tag that instructs the browser to execute a script, such as, for example, <script>malicious code</script>. The URL passed to the server would be the following:
http://www.hello.com/hello.php?name=<script>malicious code</script>

The GET or POST command would retrieve the value <script>malicious code</script> from the “name” variable and the browser would interpret this as valid HTML instruction to execute the script malicious code. The next visitor to the site would inadvertently execute the script “malicious code.”

An SQL injection exploits vulnerabilities in the database layer of an application. These vulnerabilities occur when user input is incorrectly filtered. Filtering flaws allow hackers to circumvent database authentication. One simple example is a web page asking for a user name. An attacker may enter a string that will craft an SQL command, which would grant access to the attacker. For example, attacker John Smith may enter a username of “John”, which would craft the following SQL code:
SELECT * FROM users WHERE name=‘John’

Assuming John does not have an account with the website, the above SQL statement will result in a value of “false”, which will prevent John from accessing the site. However, John may enter his user name as ‘a’ OR ‘t’=T, which would craft the following SQL code.
SELECT * FROM users WHERE name=‘a’ OR ‘t’=‘t’
   The above SQL statement will result in a value of “true,” since ‘t’ does equal ‘t’, which would grant John access to the site.

The foregoing examples are basic illustrations of how code may be inserted into dynamic websites. There are many different approaches to inserting code, and attackers are currently finding more ingenious methods of attack. Therefore, it is desirable to have a system and method that can block or remove malicious code embedded in URLs and SQL statements to protect users from attack.

### SUMMARY

In one aspect of this disclosure, a computer-implemented method and system are disclosed for real-time removal or blocking of malicious code from a string sent as a request to a server. The system and method comprises splitting the string into a first string portion and a second string portion. A first portion substring is parsed from the first string portion and compared to a list of malicious codes. If it is determined that the first portion substring matches at least one malicious code from the list of malicious codes, the first portion substring is blocked or removed from the first string portion and a cookie is inserted on a client system to prevent execution of the malicious code.

In another aspect of this disclosure, the computer-implemented method and system comprise parsing a second portion substring from the second string portion and comparing the second portion substring to the list of malicious codes. If it is determined that the second portion substring matches at least one malicious code from the list of malicious codes, the second portion substring is blocked or removed from the second string portion and a cookie is inserted on the client system to prevent the client system from executing the malicious code.

In yet another aspect of this disclosure, the computer-implemented method and system comprise parsing a substring from the main string and comparing the substring to the list of malicious codes. If it is determined that the substring matches at least one malicious code from the list of malicious codes, the substring is blocked or removed from the main string and a cookie is inserted on the client system to prevent the client system from executing the malicious code.

In another aspect of this disclosure, the computer-implemented method and system comprise parsing an IP address from a header of the request and comparing the IP address to a list of known malicious IP addresses. If the IP address matches one of the known malicious IP addresses, the request is rejected.

In another aspect of this disclosure, the computer-implemented method and system comprise parsing the request information to detect the inclusion of a file located on a remote file system that could be executed on the protected system. If it is decided that including this file could harm the protected system, the request will be denied and the attacker's info anon will be logged.

In another aspect of this disclosure the computer-implemented method and system parses the request information to detect the presence of malicious database code that could be executed on the protected system. If it is decided that this database code could harm the protected system, the request will be denied and the attacker's information will be logged.

In another aspect of this disclosure, the computer-implemented method and system parses the request information to detect the presence of any programming language that could modify the functionality of the protected system. If it is decided that this code could harm the protected system, the request will be denied and the attacker's information will be logged.

In another aspect of this disclosure, the computer-implemented method and system parses the requested information to detect the presence of client-specified terms that the client would like to disallow. If it is decided that this term is found in the request, the request will be denied and the attacker's information will be logged.

The foregoing has outlined generally the features and technical advantages of one or more embodiments of this disclosure in order that the following detailed description may be better understood. Additional features and advantages of this disclosure will be described hereinafter, which may form the subject of the claims of this application.

### BRIEF DESCRIPTION OF THE DRAWINGS

A more complete understanding of this application can be obtained when the following detailed description is considered in conjunction with the following drawings, in which:

FIG. 1 is a schematic of an illustrative computer system for real-time detection and removal or blocking of malicious code from a string sent as a client request;

FIG. 2 is a schematic of an illustrative network of computer systems;

FIG. 3 is a flowchart of a preferred sequence of steps for detecting malicious code from a client request;

FIG. 3A is a flowchart further illustrating the preferred sequence of steps for detecting malicious code from a client request;

FIG. 3B is a flowchart illustrating the preferred sequence of steps for removing malicious code embedded in a string and alerting other systems; and

FIG. 4 is a preferred sequence of steps for blocking clients whose IP address falls within a predetermined range known for embedding malicious code into client requests.

### DETAILED DESCRIPTION

A preferred system and method for eliminating any type of XSS threat or SQL injection are disclosed herein. As will be appreciated by one skilled in the art, the subject matter disclosed herein may be embodied as a system, method or computer program product. Accordingly, the present application may take the form of an entirely hardware embodiment, an entirely software embodiment (including firmware, resident software, micro-code, etc.) or an embodiment combining software and hardware aspects that may all generally be referred to herein as a “system.”

Furthermore, this application may take the form of a computer program product embodied in any tangible medium of expression having computer usable program code embodied in the medium. Any combination of one or more computer usable or computer readable medium(s) may be utilized. The computer-usable or computer-readable medium may be, for example, hut not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory, a read-only memory, an erasable programmable read-only memory (e.g. EPROM or Flash memory), an optical fiber, a portable compact disc read-only memory, an optical storage device, a transmission media such as those supporting the Internet or an intranet, or a magnetic storage device. In the context of this disclosure, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in base band or as part of a carrier wave. The computer usable program code may be transmitted using any appropriate medium, including, but not limited to wireless, wire line, optical fiber cable, RF, etc.

Computer program code for carrying out operations of this disclosure may be written in any combination of one or more web programming languages, such as, for example, PHP, Ajax or HTML. Object oriented programming languages may also be used such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

This application is described below with reference to flowchart illustrations and/or block diagrams of methods, apparatus (systems) and computer pro am products according to one or more embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions, which execute on the computer or other programmable apparatus, provide processes for implementing the functions/acts specified in the flowchart and/or block diagram block or blocks.

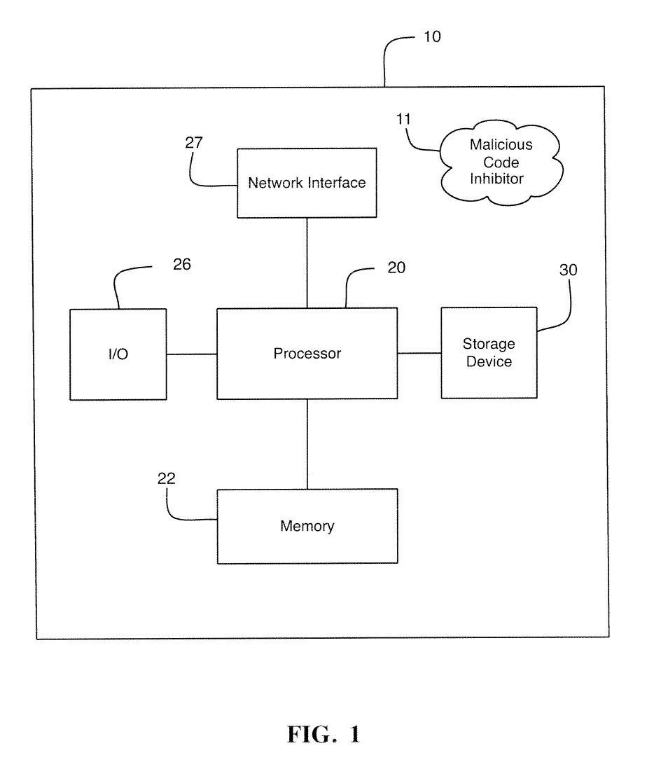

Referring to FIG. 1, a computer system 10 is shown for implementing a malicious code inhibitor 11. Computer system 10 preferably includes a processing unit 20, memory 2 input/output (“I/O”) interface 26, network interface 27, and storage device 30, all which operate in a conventional manner. Malicious code inhibitor 11 junctions to preferably load into memory 22 and have its instructions executed by processor 20. Processor 20 is preferably a collection of interconnected semiconductor transistors that transform into “on” and “off” states as the instructions of malicious code inhibitor 11 are executed. The malicious code inhibitor 11 may be part of the operating system for best efficiency. Alternatively, the operating system may invoke one or more separate software applications to employ the malicious code inhibitor 11. One skilled in the art will recognize that an implementation of an actual computer may contain additional components and that FIG. 1 contains a high level representation of some of the components of such a computer for illustrative purposes.

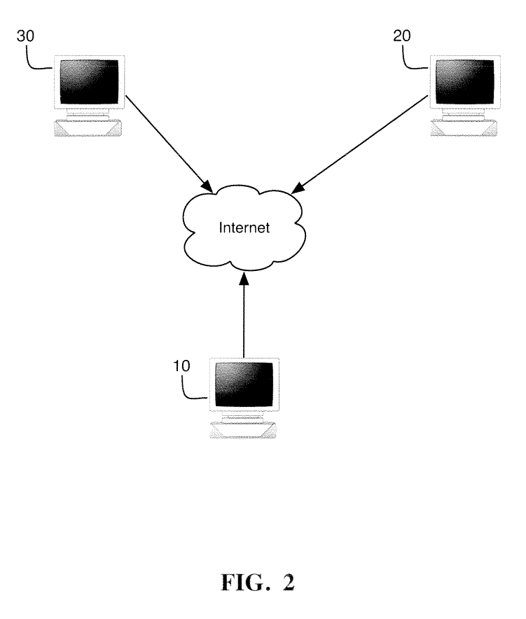

FIG. 2 shows an illustrative network of computer systems 10, 20, 30, etc. In illustrative network of FIG. 2, web server 10 is configured as the web server for illustrative purposes. The web server preferably executes the malicious code inhibitor 11. Client 20 is a computer similar in architecture to web server 10, which, in this example, is used by a victim. Computer system 30 is also a client system, which, in this example, is used by an attacker. One skilled in the art would appreciate that a network of computers may be arranged in different ways and that the network of FIG. 2 is for illustrative purposes only. While malicious code inhibitor 11 preferably executes on the web server 10, it is also understood that malicious code inhibitor 11 may execute on the client computer system 20, 30.

Malicious code inhibitor 11 preferably uses conventional “GET” or “POST” methods found in web development coding languages, such as, for example, PHP or Ajax, for retrieving all information sent to and from the URL, form input, text field, or text area by the attacking client system 30 and blocks or removes code that may be harmful to the website hosted by web server 10 and the victim's client system 20. Malicious code inhibitor 11 may also block or remove malicious code from other scripts called for server-to-server scanning.

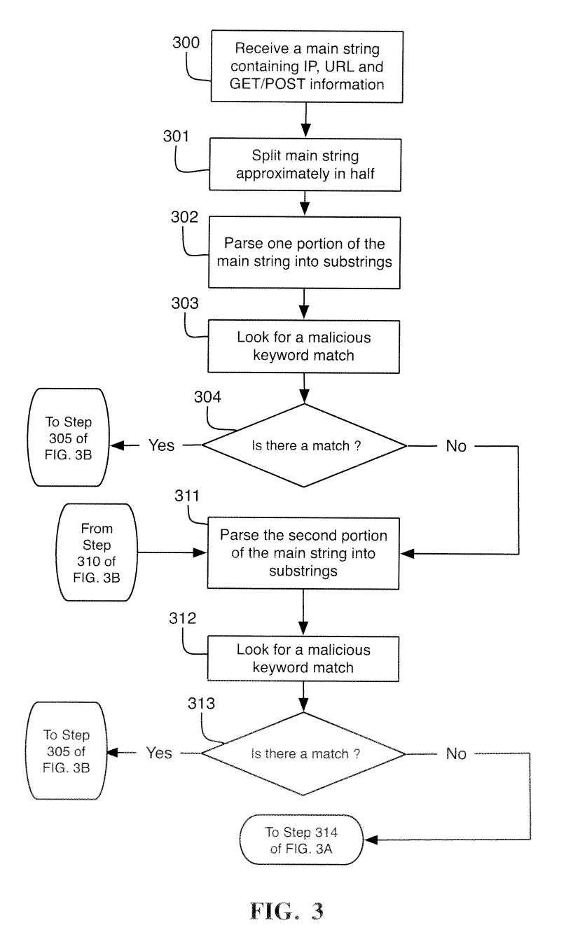

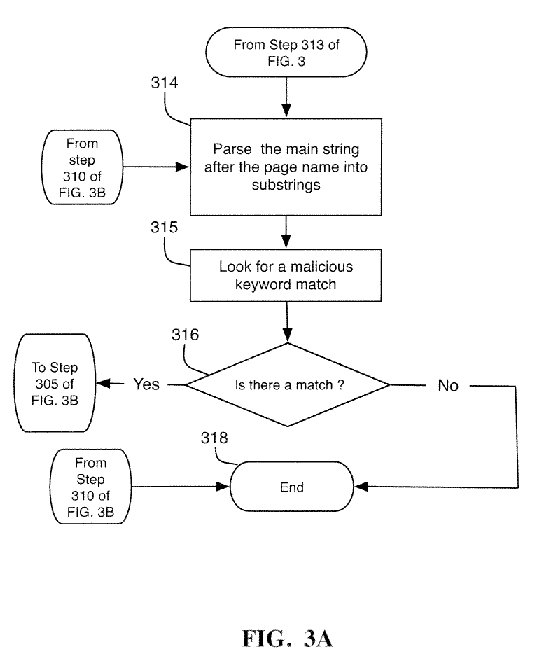

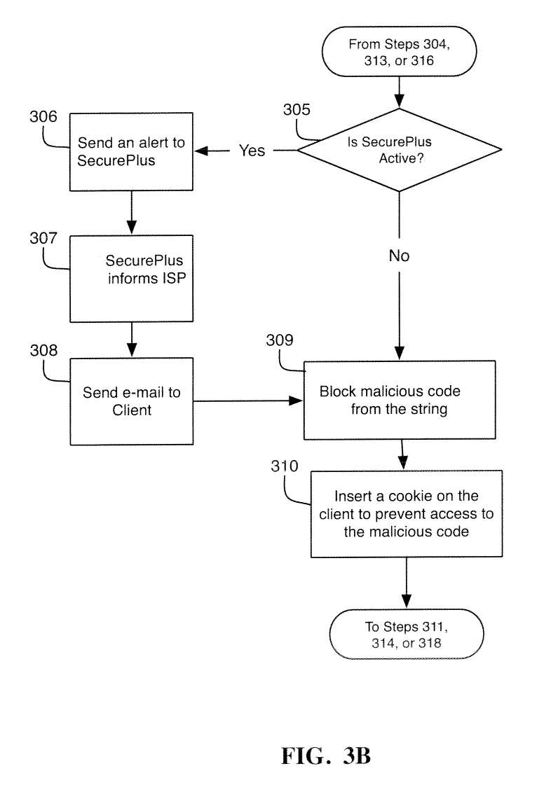

FIG. 3 illustrates a preferred sequence of steps for searching the string and removing or blocking malicious code. In step 300, a main string is preferably received containing the Internet protocol (“IP”) address of the source, the URL, and the GET/POST values. In step 301. malicious code inhibitor 11 compares that received information to databases of known attacks. The real-time malicious code inhibitor preferably splits the main string into two or more string portions. In the preferred embodiment, the main string is split approximately in half, resulting in two string portions. It is understood that the main string may be split into more than two portions and that the portions need not be equal in length.

In step 302, malicious code inhibitor 11 preferably parses substrings from one portion, preferably the right portion, of the main string. It is understood that a substring may also be a single character. In step 303, the parsed first portion substrings are preferably compared to a set of known malicious key words or malicious key groups of characters by, for example, using conventional regular expressions and pattern matching techniques. The set of malicious codes may be stored in a file, database, etc.

In step 304, malicious code inhibitor 11 determines whether there is a match between the parsed first portion substrings and the set of known malicious key words or malicious key groups of characters. If no match is found, malicious code inhibitor 11 preferably advances to step 311 of FIG. 3, which is described further below. On the other hand, if a match is found in step 304, malicious code inhibitor 11 preferably advances to step 305 of FIG. 3B.

One embodiment of malicious code inhibitor 11 includes an optional real-time monitoring service (“SecurePlus™”) that acts as a live website guardian. SecurePlus™ may provide real-time alerts to clients. Internet service (“ISPs”) and/or law enforcement agencies about an attack or an attempted attack. In step 305 of FIG. 3B, malicious code inhibitor 11 preferably determines whether the SecureLive™ feature is activated. If the SecurePlus™ feature is activated, malicious code inhibitor 11 preferably sends an alert to the SecurePlus™ representative, in step 306. In step 307, a Secureplus™ representative preferably informs the ISP of the attack. In step 308. SecureLive™ preferably sends an e-mail to the SecureLive™ representative and to the victim client system 20 to alert them of the attack.

Next, in step 309, malicious code inhibitor 11 blocks or removes the substring containing the malicious code. In step 310, malicious code inhibitor 11 preferably causes a cookie to be inserted on the victim client system 20 to prevent the victim client system from accessing the malicious code. Steps 309-310 are executed whether or not SecureLive™ is activated.

Next, malicious code inhibitor 11 preferably advances to step 311 of FIG. 3. In step 311, malicious code inhibitor 11 preferably parses substrings from the second portion, preferably the left portion, of the main string. In step 312, the parsed second portion substrings are preferably compared to a set of known malicious key words or malicious key groups of characters using, for example, conventional regular expressions and pattern matching techniques. In step 313, malicious code inhibitor 11 preferably determines if a match is found between the parsed second portion substrings and the set of known malicious key words or malicious key groups of characters. If malicious code inhibitor 11 determines that a match is found, steps 305-310 of FIG. 3B are preferably performed in the manner described above.

If no match is found in step 313, malicious code inhibitor 11 preferably parses the main string after the page name (inner portion) into substrings in step 314 of FIG. 3A. In step 315, the malicious code inhibitor 11 preferably compares these parsed substrings to a set of known malicious key words or malicious key groups of characters using, for example, conventional regular expressions and pattern matching techniques.

In step 316, malicious code inhibitor 11 preferably determines if a match is found between the parsed substrings and the set of known malicious key words or malicious key groups of characters. If a match is found, steps 305-310 of FIG. 3B are preferably executed in the manner described above. If no match is found in step 316, the malicious code inhibitor 11 preferably ends the process in step 318.

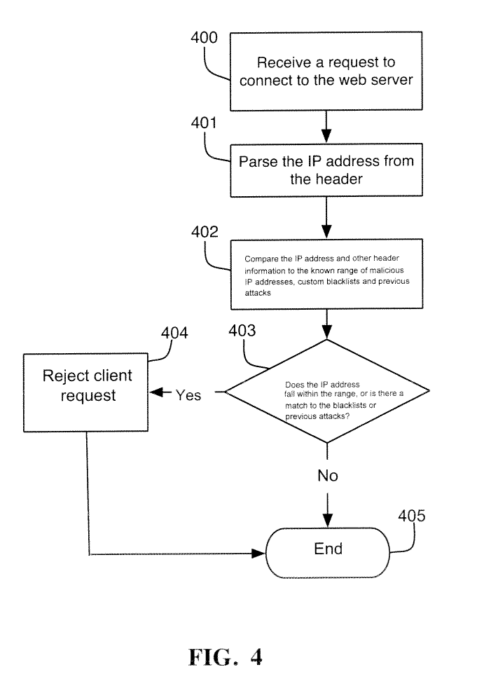

Malicious code inhibitor 11 may also maintain and/or access data in a database of known Internet protocol (“IP”) ranges that have been used by attackers. FIG. 4 illustrates a preferred sequence of steps for blocking known malicious IP addresses. In step 400, server computer system 10 preferably receives a request from a client computer system using known protocols, such as, for example, TCP/IP. In step 401, malicious code inhibitor 11 preferably parses the requesting IP address from the header record of the request. In step 402, the malicious code inhibitor 11 preferably compares the parsed IP address and requested information from the header to a listing of known range of malicious IP addresses, custom black lists, and previous attacks. In step 403, malicious code inhibitor 11 preferably determines whether the IP address and other requested information from the header falls within the range of known malicious IP addresses, or whether it matches the custom black lists and previous attacks. If the IP address falls within that range or matches the black lists or previous attacks, malicious code inhibitor 11 preferably rejects the client computer system request in step 404. Otherwise, malicious code inhibitor 11 preferably ends the process in step 405.

The flowchart and block diagrams in the figures illustrate the architecture, functionality, and operation of possible implementations of systems, methods and computer program products according to various embodiments of the present application. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Malicious code inhibitor 11 preferably conduct scans for malicious activity in real-time, instead of via a scheduled scanning. Malicious code inhibitor 11 is preferably configured to conduct a scanning operation every time a call or access is made to the protected website. The protected website thereby benefits by continuous scanning performed in real-time, whereas a website protected by scheduled scanning may remain vulnerable to suffering successful attacks in the time interval between scans.

As discussed above, malicious code inhibitor 11 may also be implemented in concert with a centralized database system that tracks attempted attacks and hacker identification information, such as, for example, a range of malicious IP addresses. This information may be used to block future attacks across an entire network of computers protected by malicious code inhibitor 11. For instance, malicious code inhibitor 11 may be installed on multiple computers 10, 20 and 30. If malicious code inhibitor 11 detects that a recent attack has occurred on computer 10, malicious code inhibitor 11 may, for example, send the information related to that attack to a centralized database that stores information on hacking attempts. The information preferably includes data, which may identify the hacker to other computers (e.g., an IP address). The centralized database preferably then sends this information immediately to other instances of malicious code inhibitor 11 running on computers 20, 30. The other instances of malicious code inhibitor 11 may then block all access by the attacker based on the attacker's identification information (e.g. the IP address) in accordance with process described above (FIG. 4). The malicious code inhibitor 11 may, therefore, protect a large number of computers from attack based on a single hack attempt.

Having described and illustrated the principles of this application by reference to one or more preferred embodiments, it should be apparent that the preferred embodiment(s) may be modified in arrangement and detail without departing from the principles disclosed herein and that it is intended that the application be construed as including all such modifications and variations insofar as they come within the spirit and scope of the subject matter disclosed herein.

What is claimed is:

1. A computer-implemented method for real-time blocking, of malicious code from a string sent as a request to a server, comprising:
splitting the string into a first string portion and a second string portion;
parsing a first portion substring from the first string portion;
comparing the first portion substring to a list of malicious codes;
blocking the first portion substring from the first string portion, if it is determined that the first portion substring matches at least one malicious code from the list of malicious codes; and
inserting a cookie on a client system, if it is determined that the first portion substring matches at least one malicious code from the list of malicious codes, wherein the cookie prevents the client system from executing the malicious code.

2. The computer-implemented method of claim 1, further comprising:
parsing a second portion substring from the second string portion;
comparing the second portion substring to the list of malicious codes;
blocking the second portion substring from the second string portion, if it is determined that the second portion substring matches at least one malicious code from the list of malicious codes; and
inserting a cookie on the client system, if it is determined that the second portion substring matches at least one malicious code from the list of malicious codes, wherein the cookie prevents the client system from executing the malicious code.

3. The computer-implemented method of claim 2, further comprising:
parsing a substring from the main string;
comparing the substring to the list of malicious codes;
removing the substring from the main string, if it is determined that the substring matches at least one malicious code from the list of malicious codes; and
inserting a cookie on the client system, if it is determined that the substring matches at least one malicious code from the list of malicious codes, wherein the cookie prevents the client system from executing the malicious code.

4. The computer-implemented method of claim 2, wherein the string is split in approximately half to define the first string portion and second string portion.

5. The computer-implemented method of claim 2, further comprising:
parsing an IP address from a header of the request;
comparing the IP address to a list of known malicious IP addresses; and
rejecting the request if the IP address matches one of the known malicious IP addresses.

6. The computer-implemented method of claim 2, further comprising:
providing a centralized database to store an identifying information regarding attempts at malicious access;
uploading the identifying information regarding an attempt at malicious access to the centralized database when the attempt a malicious access is detected;
disseminating the identifying information regarding an attempt at malicious access; and
blocking all access from a source of the attempt at malicious access based on the identifying information.

7. The computer-implemented method of claim 2, further comprising repeating method every time a new request is sent to the server.

8. The computer-implemented method of claim 2, further comprising providing a real time alert to a client when the malicious code is detected.

9. The computer-implemented method of claim 2, further comprising providing a real time alert to an internet service provider when the malicious code is detected.

10. The computer-implemented method of claim 2, further comprising providing a real time alert to a law enforcement agency when the malicious code is detected.

11. A system for real-time removal of malicious code from a string sent as a request to a server, the system comprising:
a processor; and
memory comprising program/instructions, wherein the program instructions are executable by the processor to:
split the string into a first string portion and a second string portion;
parse a first portion substring from the first string portion;
compare the first portion substring to a list of malicious codes;
remove the first portion substring from the first string portion, if it is determined that the first portion substring matches at least one malicious code from the list of malicious codes; and
insert a cookie on a client system, if it is determined that the first portion substring matches at least one malicious code from the list of malicious codes, wherein the cookie prevents the client system from executing the malicious code.

12. The system of claim 11, wherein the program instructions are further executable by the processor to:
parse a second portion substring from the second string portion;
compare the second portion substring to the list of malicious codes;
remove the second portion substring from the second string portion, if it is determined that the second portion substring matches at least one malicious code from the list of malicious codes; and
insert a cookie on the client system, if it is determined that the second portion substring matches at least one malicious code from the list of malicious codes, wherein the cookie prevents the client system from executing the malicious code.

13. The system of claim 12, wherein the program instructions are further executable by the processor to:
parse a substring from the main string;
compare the substring to the list of malicious codes;
remove the substring from the main string, if it is determined that the substring matches at least one malicious code from the list of malicious codes; and
insert a cookie on the client system, if it is determined that the substring matches at least one malicious code from the list of malicious codes, wherein the cookie prevents the client system from executing the malicious code.

14. The system of claim 12, wherein the string is split in approximately half to define the first string portion and second string portion.

15. The system of claim 12, wherein the program instructions are further executable by the processor to:
parse an IP address from a header of the request;
compare the IP address to a list of known malicious IP addresses; and
reject the request if the IP address matches one of the known malicious IP addresses.

16. The system of claim 12, wherein the program instructions are further executable by the processor to:
provide a centralized database to store an identifying information regarding attempts at malicious access;
upload the identifying information regarding an attempt at malicious access to the centralized database when the attempt at malicious access is detected;
disseminate the identifying information regarding an attempt at malicious access; and
block all access from a source of the attempt at malicious access based on the identifying information.

17. The of claim 12, wherein the program instructions are further executable by the processor to repeat every time a new request is sent to the server.

18. The system of claim 12, wherein the program instructions are further executable by the processor to provide a real time alert to a client when the malicious code is detected.

19. The system of claim 12, wherein the program instructions are further executable by the processor to provide a real time alert to an internet service provider when the malicious code is detected.

20. The system of claim 12, wherein the program instructions are further executable by the processor to provide a real time alert to a law enforcement agency when the malicious code is detected.

21. A computer-readable storage medium with an executable program stored thereon, wherein the program instructs a microprocessor to:
split the string into a first string portion and a second string portion;
parse a first portion substring from the first string portion;
compare the first portion substring to a list of malicious codes;
remove the first portion substring from the first string portion, if it is determined that the first portion substring matches at least one malicious code from the list of malicious codes; and
insert a cookie on a client system, if it is determined that the first portion substring matches at least one malicious code from the list of malicious codes, wherein the cookie prevents the client system from executing the malicious code.

22. The computer-readable storage medium of claim 21, wherein the program further instructs the microprocessor to:
parse a second portion substring from the second string portion;
compare the second portion substring to the list of malicious codes;
remove the second portion substring from the second string portion, if it is determined that the second portion substring matches at least one malicious code from the list of malicious codes; and
insert a cookie on the client system, if it is determined that the second portion substring matches at least one malicious code from the list of malicious codes, wherein the cookie prevents the client system from executing the malicious code.

23. The computer-readable storage medium of claim 22, wherein the program further instructs the microprocessor to:
parse a substring from the main string;
compare the substring to the list of malicious codes;
remove the substring from the main string, if it is determined that the substring matches at least one malicious code from the list of malicious codes; and
insert a cookie on the client system, if it is determined that the substring matches at least one malicious code from the list of malicious codes, wherein the cookie prevents the client system from executing the malicious code.

24. The computer-readable storage medium of claim 22, wherein the string is split in approximately half to define the first string portion and second string portion.

25. The computer-readable storage medium of claim 22, wherein the program further instructs the microprocessor to:
parse an IP address from a header of the request;
compare the IP address to a list of known malicious IP addresses; and
reject the request if the IP address matches one of the known malicious IP addresses.

26. The computer-readable storage medium of claim 22, wherein the program further instructs the microprocessor to:
provide a centralized database to store an identifying information regarding attempts at malicious access;
upload the identifying information regarding an attempt at malicious access to the centralized database when the attempt at malicious access is detected;
disseminate the identifying information regarding an attempt at malicious access; and
block all access from a source of the attempt at malicious access based on the identifying information.

27. The computer-readable storage medium of claim 22, wherein the program further instructs the microprocessor to repeat every time a new request is sent to the server.

28. The computer-readable storage medium of claim 22, wherein the program further instructs the microprocessor to provide a real time alert to a client when the malicious code is detected.

29. The computer-readable storage medium of claim 22, wherein the program further instructs the microprocessor to provide a real time alert to an internet service provider when the malicious code is detected.

30. The computer-readable storage medium of claim 22, wherein the program further instructs the microprocessor to provide a real time alert to a law enforcement agency when the malicious code is detected.
